(19) United States
(12) Patent Application Publication
(10) Pub. No.: US 2006/0158303 A1
(43) Pub. Date: Jul. 20, 2006

(54) Snap-together choke and transformer assembly for an electric arc welder

(75) Inventors: Craig L. Diekmann, Mentor, OH (US); Lawrence A. Boehnlein, Chardon, OH (US); Larry B. Solski, Avon, OH (US); Dale L. Bilczo, Rocky River, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: LINCOLN GLOBAL, INC.

(21) Appl. No.: 11/036,455

(22) Filed: Jan. 14, 2005

(51) Int. Cl. H01F 27/24

(52) U.S. Cl. 336/234

(57) ABSTRACT

An apparatus for an electric arc welder comprising a first electromagnetic device including a first core assembly, wherein the first core assembly has a first stack of laminations which are press-fitted or snapped together into interlocking engagement with a complementary second stack of laminations so as to form two flux paths through the first core assembly, each of which passes through a center portion of the first core assembly; a second electromagnetic device, such as a transformer, including a second core assembly, wherein the second core assembly has a first stack of laminations which are press-fitted or snapped together into interlocking engagement with a complementary second stack of laminations so as to form two flux paths through the second core assembly, each of which passes through a center portion of the second core assembly; and wherein the two core assemblies of the electromagnetic devices are press-fitted or snapped together into interlocking engagement with each other.

### FIELD OF THE INVENTION

The present invention relates generally to electromagnetic devices such as chokes and transformers and deals more particularly with an improved choke and transformer assembly that is press fitted or snapped together and may be used with electric arc welders, and it will be described with particular reference thereto. However, it is to be appreciated that the present invention is also amenable to other like applications.

### BACKGROUND

In the field of electric arc welding, it is common practice to use electromagnetic devices such as chokes and transformers in power supplies. For example, as described in Clark et al., U.S. Pat. No. 5,819,934, incorporated by reference herein, a power source, such as a single phase line voltage, may be directed through a transformer to a rectifier in a DC electric arc welder. The output circuit normally includes a capacitor in parallel across the electrode and the workpiece, with a relatively small inductance for charging the capacitor as a rectifier or power supply provides DC current. This inductance removes the ripple from the welding current. And, in series with the arc gap of the welder, there is generally provided a choke capable of handling high currents and used to control current flow for stabilizing the arc.

A transformer (or choke) generally consists of one or more coils (windings) of conducting wire, wound on a former (bobbin) that surrounds the center limb (or sometimes all limbs) of a circuit of magnetic material (core). The winding wires are insulated, and the core is made from thin sheet steel plates known as laminations (this reduces “eddy current” losses). The assembly is typically held together by clamps, which are held in place by long screws that are insulated from the rest of the structure (again, to limit eddy currents). The winding wires are either made off to terminals mounted on the clamps or the wire may leave the coil by leads.

In particular, chokes and transformers commonly have cores made up of individual laminations which may take the form of a butted stack or an interleaved stack. A variety of ways have been used to hold the laminations together to make a core for the device. They have been bolted together. They have been welded together. They have been adhered together. They have been enclosed within a retaining frame. But all these methods are costly because they involve additional components and/or add to the time and number of operations needed to assemble the core. It is desirable, therefore, to improve the ease of assembly by simply press fitting or “snapping together” the main components, while maintaining or improving upon the structural integrity and performance of the choke and transformer cores.

### BRIEF DESCRIPTION

In accordance with an aspect of the present invention, there is provided an apparatus for an electric arc welder. The apparatus comprises a first electromagnetic device including a first core assembly, wherein the first core assembly has a first stack of laminations which are press-fitted or “snapped” together into interlocking engagement with a complementary second stack of laminations so as to form two flux paths through the first core assembly, each of which passes through a center portion of the first core assembly; a second electromagnetic device, such as a transformer, including a second core assembly, wherein the second core assembly has a first stack of laminations which are press-fitted or “snapped” together into interlocking engagement with a complementary second stack of laminations so as to form two flux paths through the second core assembly, each of which passes through a center portion of the second core assembly; and wherein the two core assemblies of the electromagnetic devices are press-fitted or “snapped” into interlocking engagement with each other.

In one embodiment, the first electromagnetic device is a choke and the second electromagnetic device is a transformer. The lamination stacks comprise generally E-shaped laminations to form E-E choke and transformer cores, although E-I choke and transformer cores may be utilized in the present invention. Each stack of E-shaped laminations generally has a base portion extending between a first side edge and a second side edges and extending from each base portion is a first outer leg, a center leg and a second outer leg. The first and second outer legs of each stack of laminations have end configurations which are mirror images of each other and facilitate an intermitting engagement of the two lamination stacks, each of the end configurations including an outer edge surfaces, an inner edge surface, a camming surface, and a notch.

The apparatus generally includes a first bobbin that is mountable on the center portion of the first core assembly, the primary winding of the first core assembly wound about the first bobbin, a second bobbin that is mountable on the center portion of the second core assembly, the primary winding of the second core assembly wound about the first bobbin, and a secondary winding about the second bobbin.

Further, two outer portions and the center portion of the first core assembly make up the flux paths through the first core assembly, and the center portion of the first core assembly has a cross-sectional area that is substantially twice the cross-sectional area of either of the outer core portions.

The first stack of laminations in the first core assembly may include mounting means in each of the outside corners, where each mounting means comprises a generally L-shaped cut-out having a side wall and a bottom wall and each side wall includes a barb for biting into a plastic housing and securing the apparatus in the housing. Likewise, the second stack of laminations in the second core assembly would include mounting means in each of the outside corners, where each mounting means comprises a barb for biting into a plastic housing and securing the apparatus in the housing.

Depressed areas are provided in the lamination stacks, rectangular in shape, so as to provide a recess on one side of each lamination and a protuberance on the other side of each lamination to facilitate interlocking engagement of the laminations when they are press fitted against each other.

The pieces of lamination in each of the mating stacks of laminations are punched from the same area in a sheet of lamination blank material and the lamination pieces in one stack are arranged upside down relative to the pieces in the other stack.

Thus, the choke and transformer assembly of the present invention differs from previously proposed laminations, lamination stacks and core assemblies by providing an end formation on one outer leg of the “E” that is a mirror image of an end formation on the other outer leg of the E-shaped lamination, with each such end formation including an outer surface, an inner surface and a camming surface adapted to engage and mate with a complimentary “E” shaped lamination. The choke and the transformer are adapted to “snap together” to form a single assembly that can be mounted in a housing made of plastic or a similar material.

Thus, the advantages of the choke and transformer assembly of the present invention include a simple design, fast assembly, no welding being needed, and consistent inductance.

### BRIEF DESCRIPTION OF THE DRAWINGS

FIG. 1 is a perspective view of one embodiment of a choke and transformer assembly according to the present invention.

FIG. 2 is a front view of the choke and transformer assembly in FIG. 1 as mounted in a plastic housing.

FIG. 3 is a partial cross-sectional view of a stack of laminations taken along the line 3-3 of FIG. 2.

FIG. 4 is a front view, exploded, of the choke core of the assembly in FIG. 1.

FIG. 5 is a front view, exploded, of the transformer core of the assembly in FIG. 1.

FIGS. 6A to 6C illustrate a detailed view of a method of assembling stacks of laminations together.

FIGS. 7A to 7C illustrate a detailed view of a method of assembling two cores together.

FIG. 8 is a partial top view of a sheet of lamination material showing the laminations to be punched or stamped from the material.

FIG. 9 is a partial perspective view showing an alternative embodiment of the choke and transformer assembly.

FIG. 10 is a partial cross-sectional view of the choke-to-transformer connection taken along the line 10-10 of FIG. 9.

FIGS. 11A to 11C illustrate a detailed view of an alternative method of assembling stacks of laminations together.

FIG. 12 is a perspective view of another embodiment of the choke and transformer assembly.

FIG. 13 is a front view of the choke and transformer assembly in FIG. 12.

FIG. 14 is a front view, exploded, of the choke core of the assembly in FIG. 12.

FIG. 15 is a front view, exploded, of the transformer core of the assembly in FIG. 12.

FIGS. 16A and 16B illustrate a detailed view of a method of assembling lamination stacks for the assembly in FIG. 12.

FIGS. 17A and 17B illustrate a detailed view of a method of assembling the choke and transformer assembly shown in FIG. 12.

FIG. 18 is a front view, exploded, of laminations for an E-I choke core assembly according to the present invention.

FIG. 19 is a front view, exploded, of laminations for an E-I transformer core assembly according to the present invention.

### DETAILED DESCRIPTION

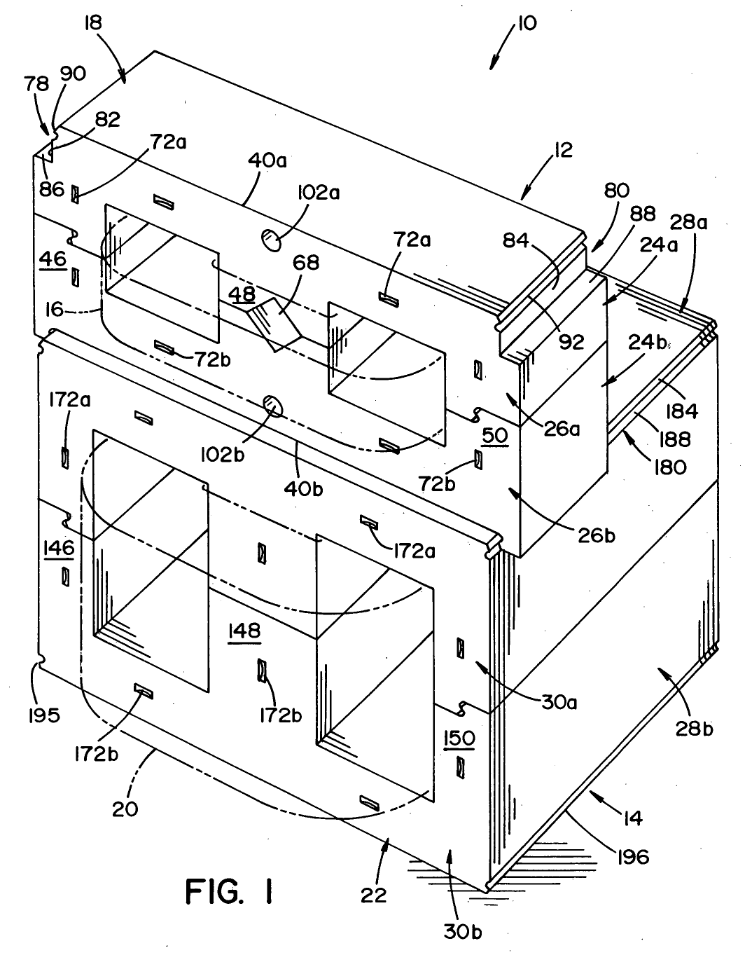

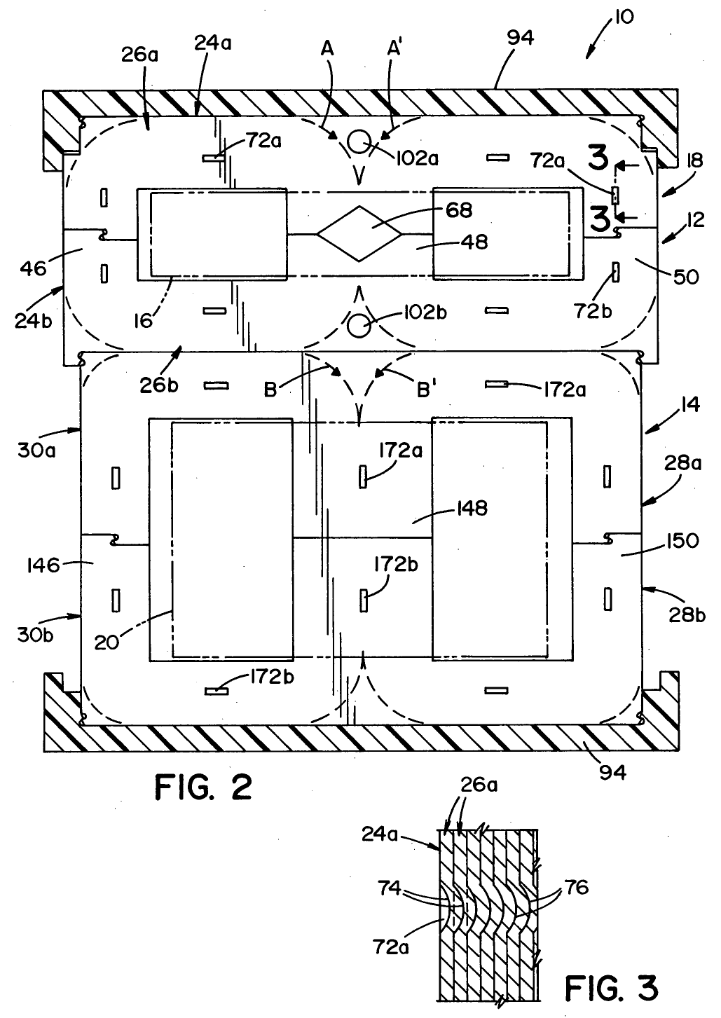

Referring now to the drawings wherein the showings are for the purpose of illustrating the preferred embodiments only and not for the purpose of limiting the same, with like numerals being used for like and corresponding parts of the various drawings, FIGS. 1 and 2 illustrate a choke and transformer assembly 10 comprising a choke 12 and a transformer 14 constructed according to the teachings of the present invention. The choke 12 includes a coil 16 (shown in phantom lines) and a choke core assembly 18. The transformer 14 includes a coil 20 (shown in phantom lines) and a transformer core assembly 22. In this embodiment, the core assemblies 18 and 22 generally feature a “double-E” or “E-E” type structure, although it is to be appreciated that other known structures may be used, such as E-I structures. Thus, the choke core assembly 18 is made up of an upper stack 24a of E-shaped laminations 26a, which are press-fitted into interlocking engagement with a complementary lower stack 24b of E-shaped laminations 26b, (i.e., they are snapped together), in accordance with the teachings of the present invention. Likewise, the transformer core assembly 22 is made up of an upper stack 28a of E-shaped laminations 30a, which are press-fitted into interlocking engagement with a complementary lower stack 28b of E-shaped laminations 30b (i.e., snapped together). The choke 12 is press-fitted into interlocking engagement with the transformer 14 (i.e., snapped together) to form the choke and transformer assembly 10.

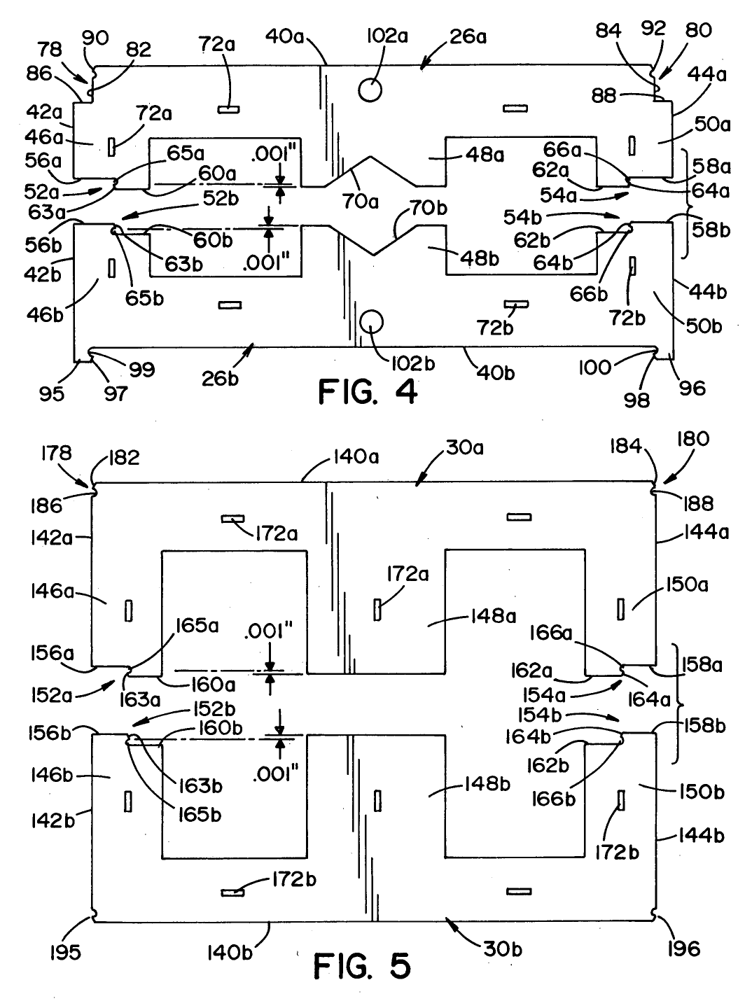

As shown in FIG. 4, each “E” lamination 26a in the upper stack 24a has a base portion 40a extending between a first side edge 42a and a second side edge 44a. Extending from the base portion 40a is a first outer leg 46a, a center leg 48a, and a second outer leg 50a. As shown, the first and second outer legs 46a and 50a have end configurations 52a and 54a, which are mirror images of each other and facilitate an interfitting engagement of the upper and lower lamination stacks 24a, 24b. The end configurations 52a, 54a include outer edge surfaces 56a, 58a, inner edge surfaces 60a, 62a, camming surfaces 63a, 64a, and notches 65a, 66a. In this embodiment, the camming surfaces 63a, 64a are flat and inclined outwardly; however, it is to be appreciated that other configurations may be utilized, such as curved camming surfaces.

DC generally flows in the windings of the choke 12. The effect is that the DC creates a magnetomotive force that is unidirectional, and this reduces the maximum AC signal that can be carried before saturation in one direction. Therefore, to combat this, chokes subject to DC in the windings utilize an air gap in the core, so that it is no longer a complete magnetic circuit, but is instead broken by the gap. As shown, a diamond-shaped symmetrical air gap 68 is provided with the abutting edge portions of the center legs 48a, 48b touching each other to define the intermediate air gap. The small air gap portions gradually increase to a large gap portion. The air gap 68 is larger at the apex or center and decreases toward both edges of the core. The advantage of this diamond-shaped air gap 68 is that it provides a generally straight line, inversely proportional relationship between current and inductance, where the relationship is optimum for electric arc welding. Thus, the center leg 48a has a V-shaped cut-out 70a, which represents the top half of the air gap 68.

For the purpose of facilitating the flat side to flat side joiner of the upper “E” laminations 26a, any number of metal displacements 72a are formed in each upper lamination 26a to form a rectangular depression or recess 74 on one side and a protuberance 76 on the other side, as shown in FIG. 3. In this embodiment, the metal displacements 72a are rectangular and four such displacements 72a are formed in the lamination 26a. It is to be understood, however, that the metal displacements 72a may be any other suitable shape, such as circular, and/or formed elsewhere on the upper lamination 26a. Each metal displacement 72a is formed by displacing part of the material in the upper lamination 26a such that the recess 74 is formed on one side opposite the protuberance 76 on the other side.

In this embodiment, the upper “E” laminations 26a include mounting means 78, 80 in the outside corners. The mounting means 78, 80 comprise generally L-shaped cut-outs having side walls 82, 84 and bottom walls 86, 88. The side walls 82, 84 feature barbs 90, 92 to assist in mounting and securing the choke and transformer assembly 10 in a housing 94 made of plastic or other suitable material. The barbs 90, 92 are adapted to “bite into” the plastic housing 94 while mounting the choke and transformer assembly 10. It is to be appreciated, however, that the upper laminations 26a may include different types of mounting means or no mounting means at all, depending upon how and where the choke and transformer assembly 10 is to be mounted.

The lower “E” laminations 26b are substantially similar to the upper “E” laminations 26a. That is, each lower “E” lamination 26b includes a base portion 40b extending between a first side edge 42b and a second side edge 44b of the “E” formation. Extending from the base portion 40b are three legs: a first outer leg 46b, a center leg 48b, and a second outer leg 50b. The first and second outer legs 46b and 50b have end configurations 52b and 54b, which are mirror images of each other. The end configurations 52b and 54b include outer edge surfaces 56b, 58b, inner edge surfaces 60b, 62b, camming surfaces 63b, 64b, and notches 65b, 66b. Additionally, a number of metal displacements 72b are formed in each lower lamination 26b for flat side to flat side joiner of laminations.

In this embodiment, the “E” laminations 26b include tabs 95, 96 in the outside corners for connecting the choke 12 to the transformer 14. The tabs 95, 96 include generally flat camming surfaces 97, 98 and notches 99, 100.

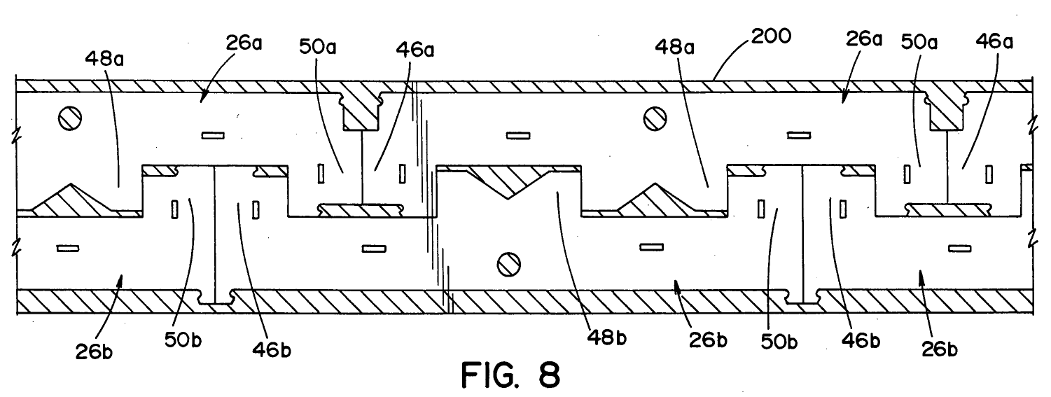

The base portions 40a, 40b of the laminations may include one or more holes 102a, 102b, respectively, which are used during the manufacturing process to help move the lamination sheet. (See FIG. 8 and description below.)

The structures of the transformer laminations 30a, 30b are similar to the choke laminations 26a, 26b described above. Thus, as shown in FIG. 5, the laminations 30a, 30b have base portions 140a, 140b extending between first side edges 142a, 142b and second side edges 144a, 144b. Extending from the base portions 140a, 140b are first outer legs 146a, 146b, center legs 148a, 148b, and second outer legs 150a, 150b.

In this embodiment, the first and second outer legs 146a and 150a of the upper laminations 30a have end configurations 152a and 154a, which are mirror images of each other and facilitate an interfitting engagement of the two lamination stacks 28a, 28b. The end configurations 152a and 154a include outer edge surfaces 156a, 158a, inner edge surfaces 160a, 162a, camming surfaces 163a, 164a, and notches 165a, 166a. Likewise, the first and second outer legs 146b and 150b of the lower laminations 30b have end formations 152b and 154b, which are mirror images of each other. The end configurations 152b and 154b include outer edge surfaces 156b, 158b, inner edge surfaces 160b, 162b, camming surfaces 163b, 164b, and notches 165b, 166b. To permit flat side to flat side joinder of the “E” laminations 30a, 30b, a number of metal displacements 172a, 172b are formed directly in the laminations.

In this embodiment, the upper laminations 30a include connecting means 178, 180 in the outside corners for connecting the choke 12 to the transformer 14. In this embodiment, the mounting means 178, 180 include generally flat camming surfaces 182, 184 and notches 186, 188.

It is to be appreciated that the lower “E” laminations 30b may also include barbs 195, 196 in the outside corners to facilitate mounting and securing the choke and transformer assembly 14 in the plastic housing 94.

When press-fitted or “snapped” together, the upper and lower lamination stacks 24a, 24b form the choke core 18. Specifically, the first outer legs 46a, 46b contact each other to form one outer portion (generally referred to herein as 46), the center legs 48a, 48b contact each other to form a center portion (generally referred to herein as 48) and the second outer legs 50a, 50b contact each other to form a second outer portion (generally referred to herein as 50). In the illustrated embodiment, the center portion 48 is thicker (or wider) than the outer portions 46, 50, although any desired width or thickness of the center leg portion can be provided.

In this embodiment, the center portion 48 of the choke core 18 is pre-loaded. That is, the center legs 48a, 48b are approximately 0.001″ longer than the first outer legs 46a, 46b and the second outer legs 50a, 50b, as best seen in FIG. 4. Likewise, the center portion 148 of the transformer core 22 is pre-loaded. Thus, the center legs 148a, 148b are approximately 0.001″ longer than the first outer legs 146a, 146b and the second outer legs 150a, 150b as best seen in FIG. 5. Pre-loading helps make a tighter fit when the lamination stacks are assembled together.

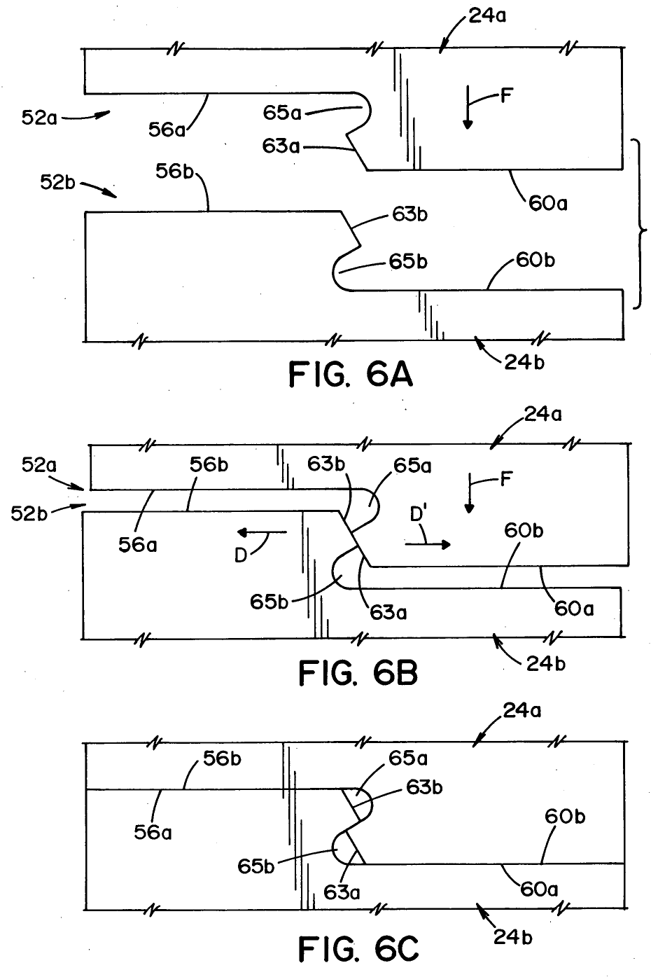

Reference is now made to FIGS. 6A to 6C, which show a method of assembling the stacks of laminations 24a, 24b. By way of example, the connection of the complementary end configurations 52a and 52b are shown. Thus, as a downward force F is exerted on the upper stack 24a, the camming surfaces 64a, 64b are forced together. As a result of the camming action between the two surfaces 65a, 65b, the lamination stacks 24a, 24b move slightly in opposing directions D, D′. When the opposing surfaces 62a, 62b and 58a, 58b meet, the lamination stacks 24a, 24b are locked in place. The camming action causes the lamination stacks 24a, 24b to mechanically engage each other in an interference fit, which locks them tightly together and minimizes vibrations in the laminations. The lamination stacks 24a, 24b formed in this manner and the resulting choke core assembly 18 formed are. very rigid with good metal-to-metal contact and low reluctance. The lamination stacks 28a, 28b of the transformer core assembly 22 are assembled in a similar fashion.

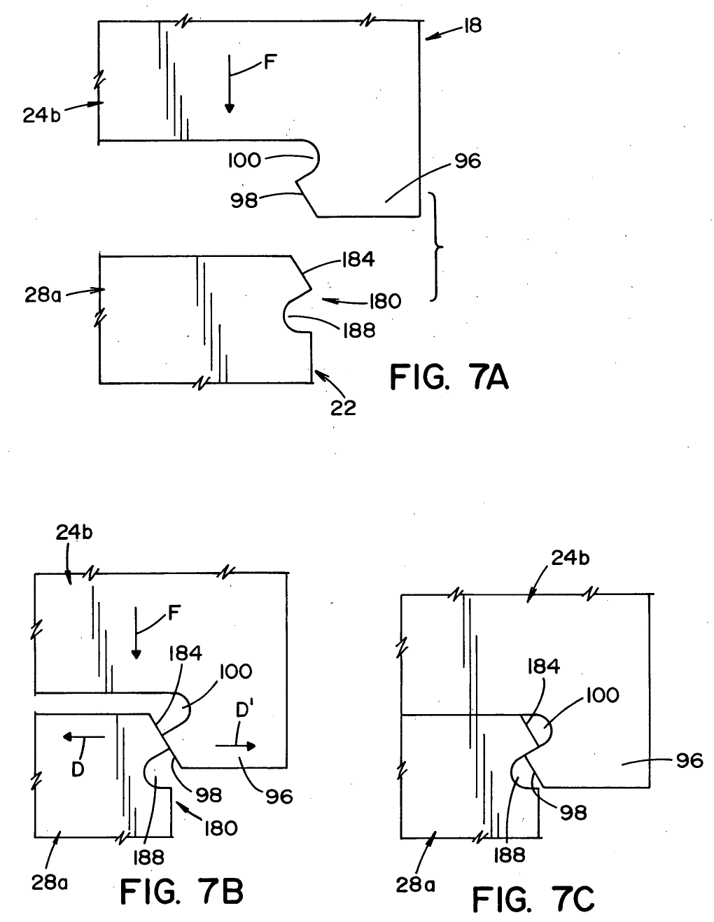

Reference is now made to FIGS. 7A to 7C, which illustrate a method of connecting the choke and transformer core assemblies 18, 22. By way of example, the connection of the complementary tab 96 and connecting means 180 is shown. Thus, as a downward force F is exerted, the camming surface 98 of the tab 96 is forced against the camming surface 184 of the mounting means 180. As a result of the camming action between the two camming surfaces 98, 184, the lamination stacks 24b, 28a move slightly in opposing directions D, D′. When the bottom portion of the choke lamination stack 24b and the top of the transformer lamination stack 28a meet, the stacks are locked in place. The camming action causes the stacks 24b, 28a to mechanically engage each other in an interference fit, which locks them tightly together.

The coil windings of the choke 12 are located about the center section 48 of the choke core 18, while the primary and secondary windings of the transformer 14 are located about the center section 148 of the transformer core 22. However, to simplify the winding of the transformer and/or the choke coils, a bobbin (not shown) may be used which fits over the center portion of each core. Prior to locating each bobbin (or otherwise insulated coil) on the center portions of the transformer and or the choke, the coils of the transformer and/or the choke are wound on the bobbin(s). The conductors (magnet wire and/or ribbon style) of the choke and transformer windings are shown only in phantom lines. Those skilled in the art will recognize that in each of FIGS. 1 and 2, the windings of the choke and transformer may be wound about the bobbin(s), and ordinarily would be viewable from the perspective of these figures. However, a bobbin is not a requirement for this assembly to work. For example, there may be no bobbin for the choke, as the coil for the choke may be insulated after winding.

When the cores are assembled as shown in FIG. 2, the primary and secondary windings have flux paths which coincide within the center portion of each core. This is demonstrated by the schematic cross-sectional front view of the choke and transformer assembly in FIG. 2. As shown, the magnetic coupling between the two windings is provided by the flux paths for each winding passing through the center portion of the core. For example, the flux path for the primary winding may be that indicated by the dashed line A, while the flux path for the secondary winding may be that indicated by the dashed line A′, in the choke core 18 (although those skilled in the art will recognize that the flux direction depends on the winding direction of the primary and secondary coils). In this embodiment, the center portion 48 of the choke core 18 has twice the cross-sectional area of each of the outer portions 46 and 50. This allows for the desired flux density in the core 18, with all of the magnetic flux passing through the center portion 48, and half of the total flux density passing through each of the outer portions 46 and 50. The same is generally true for the transformer core 22, wherein the flux path for the primary winding may be that indicated by the dashed line B. Preferably, the holes 102a, 102b do not lay within the flux paths A, A′.

As noted earlier, a bobbin wound coil or otherwise insulated coil fits over the center portion of each core. Typically, a bobbin is constructed of plastic, and may be, for example, injection molded. The bobbin is sized to fit snugly about the center legs of the choke and transformer core, respectively, so as to minimize the distance between the windings and the center portion of each core. The small gaps which will necessarily exist between the two stacks 24a, 24b help to prevent the possibility of core saturation under DC conditions.

The upper and lower laminations 26a, 26b may be formed from a sheet 200 of lamination material, as in FIG. 8. The general outline of the lamination pieces 26a, 26b, which are punched or stamped in a single punching or stamping of the sheet 200 of material, is shown. It is seen that several “E” shaped upper laminations 26a and several “E” shaped lower laminations 26b are punched or stamped from the sheet 200 of material. The upper laminations 26a may be punched from the space between the outer legs 46b, 50b and the center leg 48b of two of the lower laminations 26b.

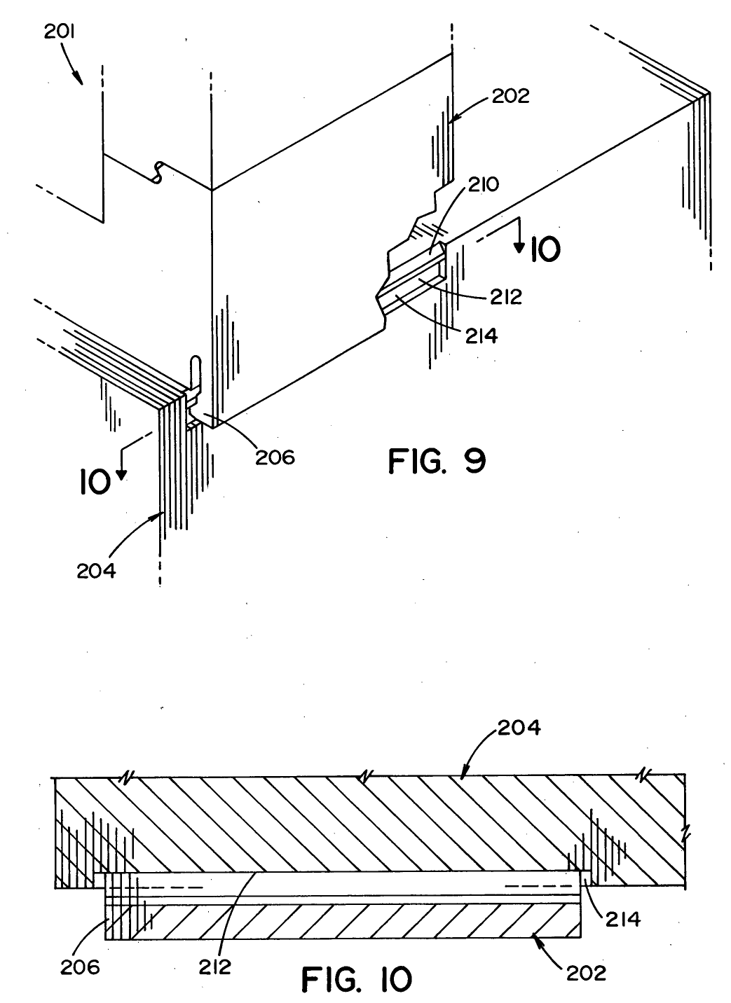

FIGS. 9 to 11 show an alternative choke and transformer assembly 200 and, more particularly, the connection of the choke core 202 to the transformer core 204. The laminations in the choke core 202 include a slotted tab 206, which includes a camming surface 208. Some of the laminations in the transformer core 204 include a camming surface 210 and a slot 212. When these laminations are stacked together, a groove 214 is formed. By adjusting the number of laminations that include the camming surface 210 and the slot 212, the groove 214 may be “turned off and on” to provide automatic positioning of the choke core 202 onto the transformer core 204, as in FIG. 10.

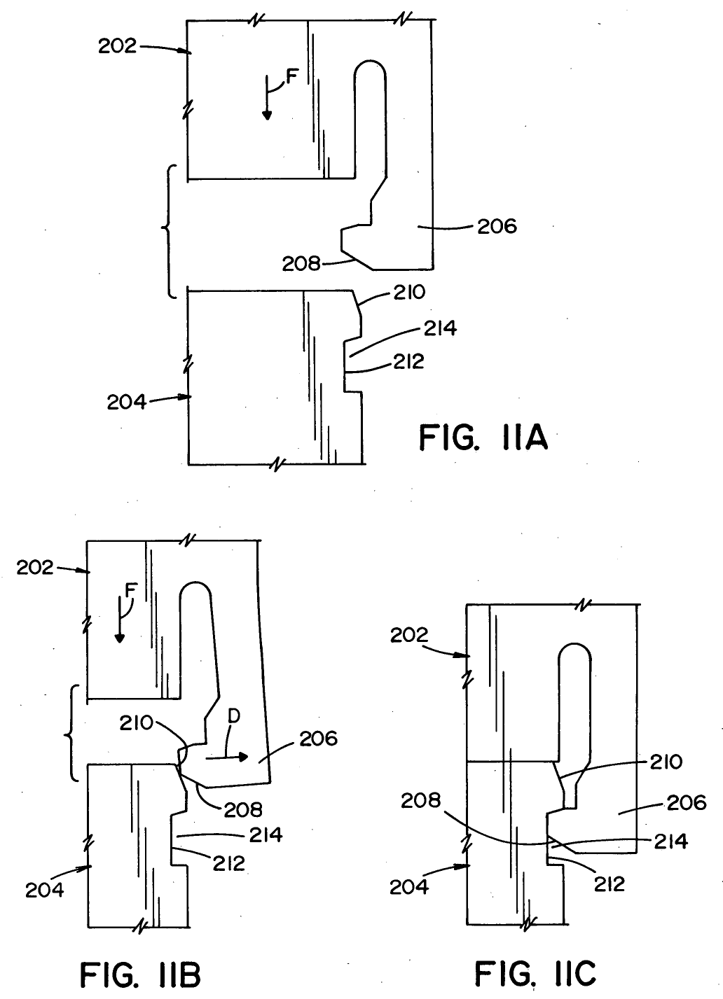

FIGS. 11A to 11C illustrate a method of assembling the choke and transformer core assemblies 202, 204 together. As a downward force F is exerted on the choke core 202, the camming surfaces 208 of the slotted tab 206 are forced against the camming surfaces 210. As a result of the camming action between the two camming surfaces 208, 210, the laminations stacks move slightly in opposing directions D, D′. Finally, the ends of the tabs 206 sit securely in the groove 214 and the cores 202, 204 are locked in place. The camming action causes the cores 202 and 204 to mechanically engage each other in an interference fit, which locks them tightly together.

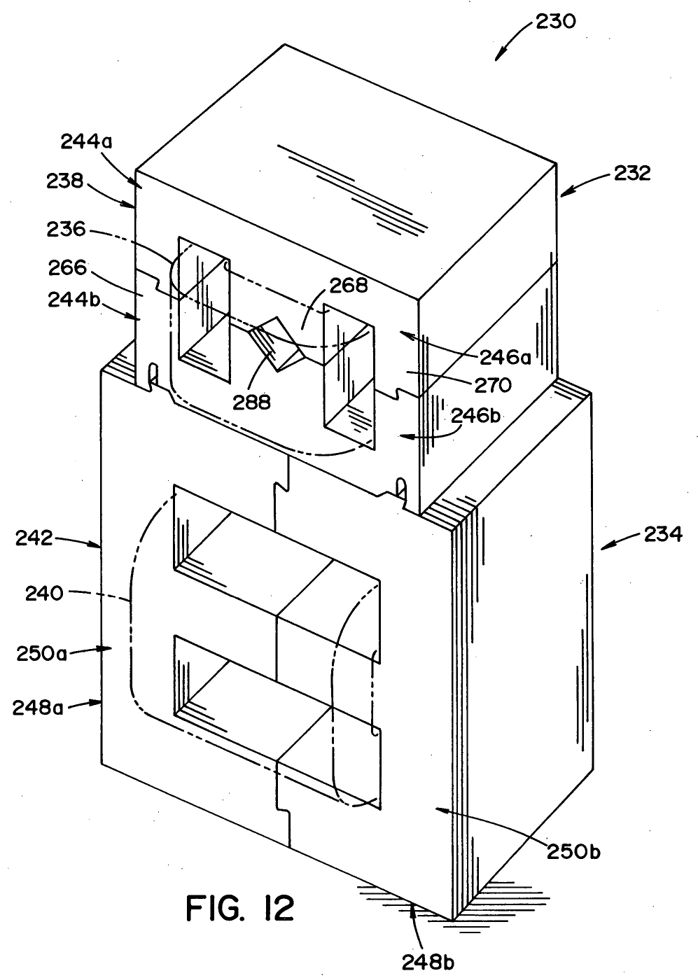

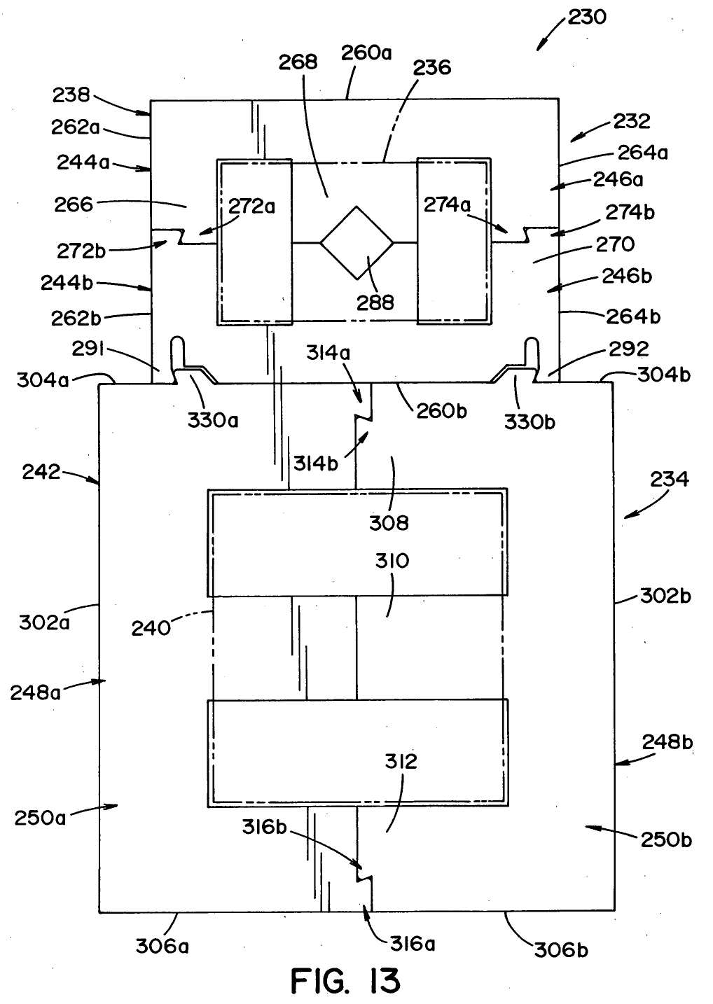

FIGS. 12 and 13 illustrate another embodiment of a choke and transformer assembly 230 comprising a choke 232 and a transformer 234 constructed according to the teachings of the present invention. The choke 232 includes a coil 236 (shown in phantom lines) and a choke core assembly 238. The transformer 234 includes a coil 240 (shown in phantom lines) and a transformer core assembly 242. In this embodiment, the choke core assembly 238 is made up of an upper stack 244a of E-shaped laminations 246a, which are press-fitted into interlocking engagement with a complementary lower stack 244b of E-shaped laminations 246b, in accordance with the teachings of the present invention. Likewise, the transformer core assembly 242 is made up of a left stack 248a of E-shaped laminations 250a, which are press-fitted into interlocking engagement with a complementary right stack 248b of E-shaped laminations 250b. The choke 232 is press-fitted into interlocking engagement with the transformer 234 to form the choke and transformer assembly 230.

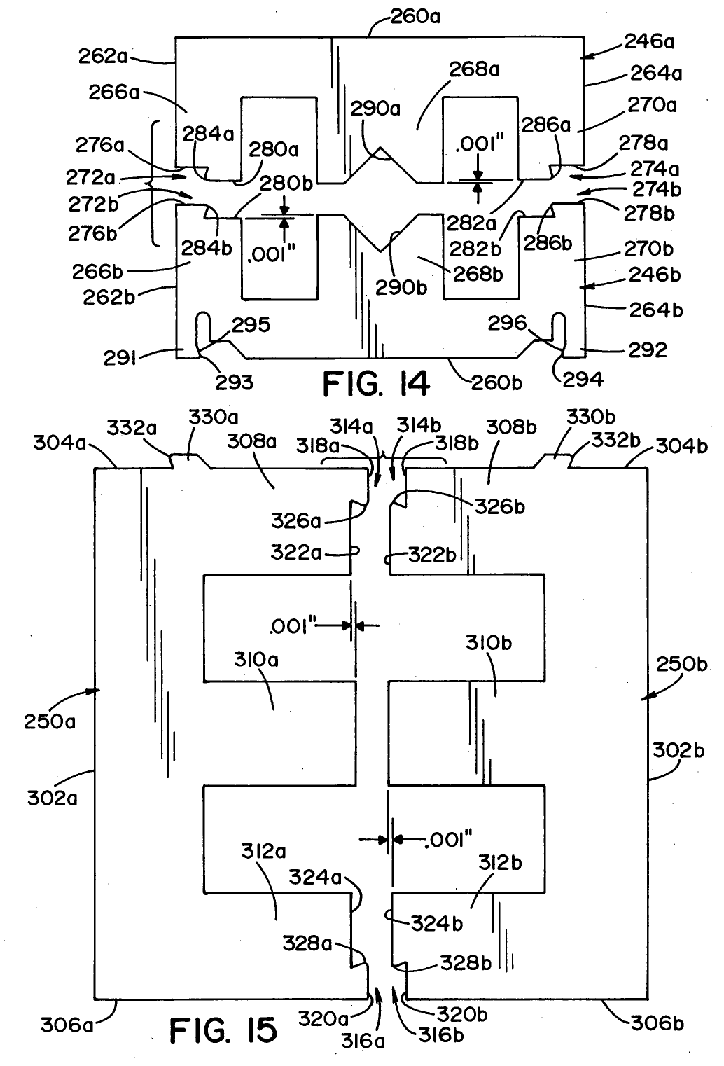

As shown in FIG. 14, each upper “E” lamination 246a has a base portion 260a between a first side edge 262a and a second side edge 264a of the “E” formation. Extending from the base portion 260a is a first outer leg 266a, a center leg 268a, and a second outer leg 270a. As shown, the first and second outer legs 266a and 270a have end formations 272a and 274a, which are mirror images of each other (other configurations are possible) and include outer edge surfaces 276a, 278a, inner edge surfaces 280a, 282a, and connecting generally S-shaped surfaces 284a, 286a.

A diamond-shaped symmetrical air gap 288 is provided in the center legs 268a, 268b. Thus, the center. leg 268a has a V-shaped cut-out 290a, which represents the top half of the air gap 288. Further, the center leg 268a is thicker than the outer legs 266a, 270a, although any desired width or thickness of the center leg 266a can be provided.

The lower “E” laminations 246b are substantially similar to the upper “E” laminations 246a. That is, each lower “E” lamination 246b includes a base portion 260b between a first side edge 262b and a second side edge 264b of the “E” formation. Extending from the base portion 260b is a first outer leg 266b, a center leg 268b, and a second outer leg 270b. The first and second outer legs 266b and 270b have end formations 272b and 274b, which are mirror images of each other and include outer edge surfaces 276b, 278b, inner edge surfaces 280b, 282b, and connecting generally S-shaped surfaces 284b, 286b. The center leg 268b has a V-shaped cut-out 290b, which represents the bottom half of the air gap 288. Further, the center leg 268b is thicker than the outer legs 266b, 270b.

In this embodiment, the lower “E” laminations 246b include a pair of slotted tabs 291, 292 in the outside corners for connecting the choke 232 to the transformer 234. The slotted tabs 291, 292 have rounded ends 293, 294 and angled surfaces 295, 296.

Turning now to FIG. 15, which shows the laminations of the transformer 234 in greater detail, each left “E” lamination 250a has a base portion 302a between a top edge 304a and a bottom edge 306a of the “E” formation. Extending from the base portion 302a is a first outer leg 308a, a center leg 310a, and a second outer leg 312a. As shown, the first and second outer legs 310a and 312a have end formations 314a and 316a, which are mirror images of each other and include outer edge surfaces 318a, 320a, inner edge surfaces 322a, 324a, and connecting generally S-shaped surfaces 326a, 328a.

The center leg 310a is generally thicker (or wider) than the outer legs 308a, 312a, although any desired width or thickness of the center leg 310a can be provided.

The right “E” laminations 250b are similar to the “E” laminations 250a. That is, each lamination 250b includes a base portion 302b between a top edge 304b and a bottom edge 306b of the “E” formation. Extending from the base portion 302b is a first outer leg 308b, a center leg 310b, and a second outer leg 312b. The first and second outer legs 308b and 312b have an end formation 314b and 316b, which are mirror images of each other and include outer edge surfaces 318b, 320b, inner edge surfaces 322b, 324b, and connecting generally “S” shaped surfaces 326b, 328b.

The laminations 250a, 250b include rigid tabs 330a, 330b on the top edges 304a, 304b. The tabs 330a, 330b include curved corner surfaces 332a, 332b on one side.

In this embodiment, the center portion 268 of the choke core 238 is pre-loaded. That is, the center legs 268a, 268b are approximately 0.001″ longer than the first outer legs 266a, 266b and the second outer legs 270a, 270b, as best seen in FIG. 14. Likewise, the center legs 310a, 310b are approximately 0.001″ longer than the first outer legs 308a, 308b and the second outer legs 312a, 312b. This helps make a tighter fit when the lamination stacks are assembled together.

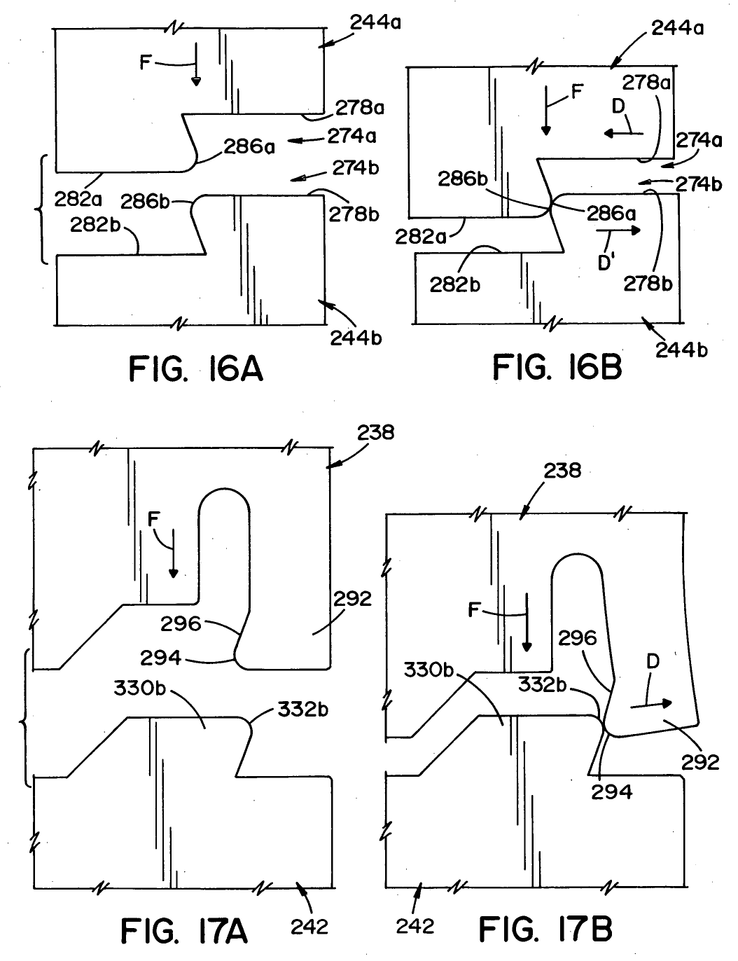

FIGS. 16A and 16B illustrate a method of assembling the stacks of laminations 244a, 244b together. By way of example, the connection of the complementary end configurations 274a and 274b are shown. As a downward force F is exerted on the upper stack 244a, the S-shaped surface 284a is forced against the S-shaped surface 284b. As a result of the camming action between the two surfaces 284a, 284b of the lamination stacks 244a, 244b move slightly in opposing directions D, D′, respectively. Finally, the opposing surfaces of the upper and lower laminations meet, and the lamination stacks 244a, 244b are locked in place. The camming action causes the lamination stacks 244a, 244b to mechanically engage each other in an interference fit, which locks them tightly together. The lamination stacks 248a, 248b of the transformer core are assembled in a similar manner.

FIGS. 17A and 17B illustrate a method of assembling the choke and transformer core assemblies 238, 242 together. By way of example, the connection of the slotted tab 96 and the rigid tab 330b is shown. As a downward force F is exerted on the choke core 238, the curved surfaces 294 of the slotted tabs 292 are forced against the curved corner surfaces 332b of the rigid tabs 330b. As a result of the camming action between the two surfaces 294, 332b, the slotted tabs 292 move slightly in an outward direction D. Finally, the bottom portion of the choke core 238 and the top of the transformer core 242 meet, and the core assemblies 238, 242 are locked in place. The camming action causes the core assemblies 238 and 242 to mechanically engage each other in an interference fit, which locks them tightly together. In this embodiment, the laminations of the respective cores are stacked such that they run perpendicular to each other. Accordingly, connecting the choke to the transformer in this manner helps to strengthen the connection between the lamination stacks in the transformer.

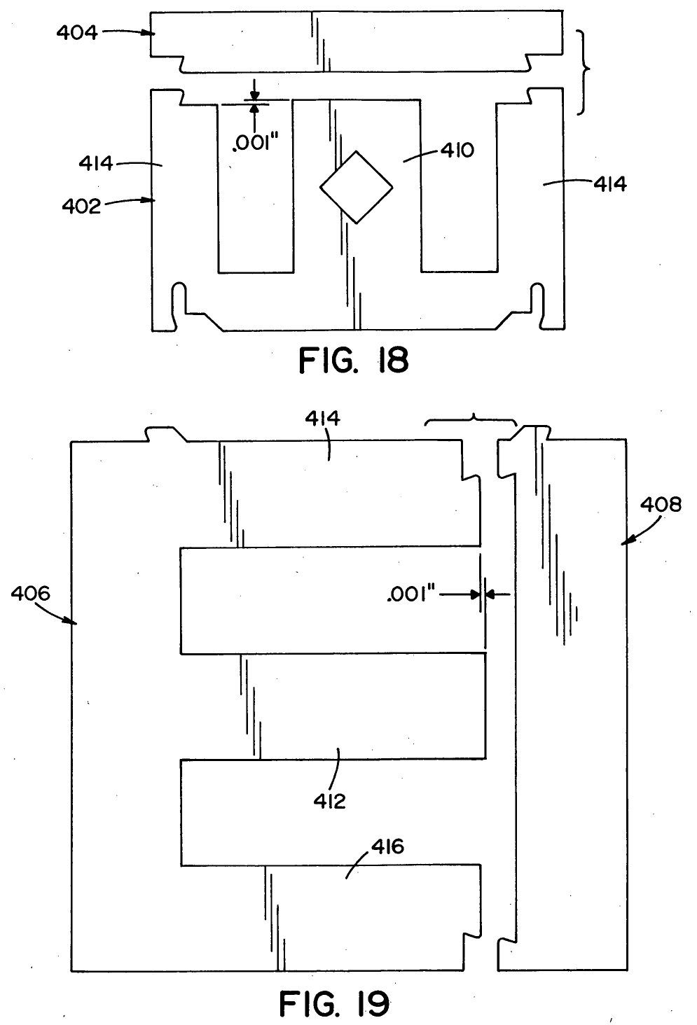

It is to be appreciated that E-I choke and transformer cores may be utilized in the present invention, as shown in FIGS. 18 and 19, for example. FIG. 18 illustrates an E-shaped lamination 402 and an I-shaped lamination 404, which may be connected or “snapped together” to form an E-I choke core as described earlier and as shown in FIGS. 16A and 16B. Likewise, FIG. 19 illustrates an E-shaped lamination 406 and an I-shaped lamination 408, which may be “snapped together” to form an E-I transformer core in a similar fashion. Further, the laminations 402, 406, and 408 include means for interconnecting the choke and transformer that are formed from the laminations 402, 404, 406, and 408, as shown in FIGS. 17A and 17B, for example. The cores may also be pre-loaded, wherein the center legs 410, 412 are approximately 0.001″ longer than the outer legs 414, 416, respectively.

There is an enormous range of core materials that may be used, even within the same basic class. As known to those skilled in the art, the cores cannot be solid and electrically conductive, or excessive eddy current will flow, heating the cores and causing very high losses. Therefore, the cores generally use thin metal laminations, each electrically insulated from the next. Possible alloys include Silicon Steel, Cold Rolled Grain Oriented Silicon Steel (CRGO), and Cold Rolled Non Grain Oriented Silicon Steel (CRNGO).

It will also be apparent that modifications can be made to the laminations, the stacks formed therefrom and the choke and transformer core assemblies formed from the stacks without departing from the teachings of the present invention. For example, the assembly could include two chokes or two transformers. Accordingly the scope of the invention is only to be limited as necessitated by the accompanying claims.

What is claimed is:

1. an apparatus for an electric arc welder, comprising:
a first electromagnetic device including a first core assembly, wherein the first core assembly includes a first stack of laminations which are press-fitted into interlocking engagement with a complementary second stack of laminations so as to form two flux paths through the first core assembly, each of which passes through a center portion of the first core assembly;
a second electromagnetic device including a second core assembly, wherein the second core assembly has a first stack laminations which are press-fitted into interlocking engagement with a complementary second stack of laminations so as to form two flux paths through the second core assembly, each of which passes through a center portion of the second core assembly; and
wherein the two core assemblies of the electromagnetic devices are press-fitted into interlocking engagement with each other.

2. The apparatus defined in claim 1, wherein at least one of the first and second stacks of laminations in the first electromagnetic device includes E-shaped laminations.

3. The apparatus defined in claim 1, wherein at least one of the first and second stacks of laminations in the second electromagnetic device includes E-shaped laminations.

4. The apparatus defined in claim 1, wherein at least one of the first and second stacks of laminations in the first electromagnetic device includes I-shaped laminations.

5. The apparatus defined in claim 1, wherein at least one of the first and second stacks of laminations in the second electromagnetic device includes E-shaped laminations.

6. The apparatus defined in claim 1, wherein the first and second stacks of laminations in the first electromagnetic device are stacks of E-shaped laminations and the first and second stacks of laminations in the second electromagnetic device are stacks of E-shaped laminations.

7. The apparatus defined in claim 6, wherein each stack of laminations has a base portion extending between a first side edge and a second side edges and extending from each base portion is a first outer leg, a center leg and a second outer leg.

8. The apparatus defined in claim 7, wherein the first and second outer legs of each stack of laminations have end configurations which are mirror images of each other and facilitate an interfitting engagement of the two lamination stacks, each of the end configurations including an outer edge surfaces, an inner edge surface, a camming surface, and a notch.

9. The apparatus defined in claim 1, further comprising;
a first bobbin that is mountable on the center portion of the first core assembly, the primary winding of the first core assembly wound about the first bobbin;
a second bobbin that is mountable on the center portion of the second core assembly, the primary winding of the second core assembly wound about the first bobbin; and
a secondary winding about the second bobbin.

10. The apparatus defined in claim 1, wherein at least one of the first and second electromagnetic devices is a choke.

11. The apparatus defined in claim 1, wherein at least one of the first and second electromagnetic devices is a transformer.

12. The apparatus defined in claim 1, wherein the first electromagnetic device is a choke and the second electromagnetic device is a transformer.

13. The apparatus defined in claim 1, wherein the center portion of the first core assembly has a diamond-shaped symmetrical air gap.

14. The apparatus defined in claim 1, wherein two outer portions and the center portion of the first core assembly make up the flux paths through the first core assembly, and wherein the center portion of the first core assembly has a cross-sectional area that is substantially twice the cross-sectional area of either of the outer core portions.

15. The apparatus defined in claim 1, wherein the laminations in the first core assembly includes a plurality of metal displacements forming a rectangular depression on one side and a protuberance on the other side for facilitating joinder of the laminations.

16. The apparatus defined in claim 15, wherein the laminations in the second core assembly includes a plurality of metal displacements forming a rectangular depression on one side and a protuberance on the other side for facilitating joinder of the laminations.

17. The apparatus defined in claim 1, wherein the first stack of laminations in the first core assembly includes mounting means in each of the outside corners, each mounting means comprising a generally L-shaped cut-out having a side wall and a bottom wall, each side wall including a barb for biting into a plastic housing and securing the apparatus in the housing.

18. The apparatus defined in claim 17, wherein the second stack of laminations in the second core assembly includes mounting means in each of the outside corners, each mounting means comprising a barb for biting into a plastic housing and securing the apparatus in the housing.

19. The apparatus defined in claim 1, wherein the center portions of the core assemblies are pre-loaded.

20. The apparatus defined in claim 1, wherein the first electromagnetic device is mounted on top of the second electromagnetic device.

21. In an electric arc welder, a choke core assembly including a first stack of laminations which are press-fitted into interlocking engagement with a complementary second stack of laminations so as to form two flux paths through the core assembly, each of which passes through a center portion of the core assembly.

22. The choke core assembly defined in claim 21, wherein the first stack of laminations is a stack of E-shaped laminations and the second stack of laminations is a stack of E-shaped laminations.

23. The choke core assembly defined in claim 22, wherein each stack of laminations has a base portion extending between a first side edge and a second side edges and extending from each base portion is a first outer leg, a center leg and a second outer leg.

24. The choke core assembly defined in claim 23, wherein the first and second outer legs of each stack of laminations have end configurations which are mirror images of each other and facilitate an interfitting engagement of the two lamination stacks, each of the end configurations including an outer edge surfaces, an inner edge surface, a camming surface, and a notch.

25. The choke core assembly defined in claim 21, wherein the first stack of laminations is a stack of E-shaped laminations and the second stack of laminations is a stack of I-shaped laminations.

26. The choke core assembly defined in claim 21, further comprising a bobbin that is mountable on the center portion of the first core assembly, the primary winding of the first core assembly wound about the first bobbin, and a secondary winding about the bobbin.

27. The choke core assembly defined in claim 21, wherein the center portion of the core assembly has a diamond-shaped symmetrical air gap.

28. The choke core assembly defined in claim 21, wherein two outer portions and the center portion of the core assembly make up the flux paths through the core assembly, and wherein the center portion of the core assembly has a cross-sectional area that is substantially twice the cross-sectional area of either of the outer core portions.

29. The choke core assembly defined in claim 21, wherein the laminations in the core assembly include a plurality of metal displacements forming a rectangular depression on one side and a protuberance on the other side for facilitating joinder of the laminations.

30. In an electric arc welder, a transformer core assembly including a first stack of laminations which are press-fitted into interlocking engagement with a complementary second stack of laminations so as to form two flux paths through the core assembly, each of which passes through a center portion of the core assembly.

31. The transformer core assembly defined in claim 30, wherein the first stack of laminations is a stack of E-shaped laminations and the second stack of laminations is a stack of E-shaped laminations.

32. The transformer core assembly defined in claim 31, wherein each stack of laminations has a base portion extending between a first side edge and a second side edges and extending from each base portion is a first outer leg, a center leg and a second outer leg.

33. The transformer core assembly defined in claim 32, wherein the first and second outer legs of each stack of laminations have end configurations which are mirror images of each other and facilitate an interfitting engagement of the two lamination stacks, each of the end configurations including an outer edge surfaces, an inner edge surface, a camming surface, and a notch.

34. The transformer core assembly defined in claim 30, wherein the first stack of laminations is a stack of E-shaped laminations and the second stack of laminations is a stack of I-shaped laminations.

35. The transformer core assembly defined in claim 30, further comprising a bobbin that is mountable on the center portion of the first core assembly, the primary winding of the first core assembly wound about the first bobbin, and a secondary winding about the bobbin.

36. The transformer core assembly defined in claim 30, wherein two outer portions and the center portion of the core assembly make up the flux paths through the core assembly, and wherein the center portion of the core assembly has a cross-sectional area that is substantially twice the cross-sectional area of either of the outer core portions.

37. The transformer core assembly defined in claim 30, wherein the laminations in the core assembly include a plurality of metal displacements forming a rectangular depression on one side and a protuberance on the other side for facilitating joinder of the laminations.
